(19) United States
(12) Patent Application Publication
(10) Pub. No.: US 2014/0288941 A1
(43) Pub. Date: Sep. 25, 2014

(54) CASE SCHEDULING, LOGISTICS MANAGEMENT AND ASSOCIATED DATA MANAGEMENT

(71) Applicant: Mark Roady, Scottsdale, AZ (US)

(72) Inventor: Mark Roady, Scottsdale, AZ (US)

(73) Assignees: ARIZONA S-CORP.; MAR MANAGEMENT, INC.

(21) Appl. No.: 13/849,910

(22) Filed: Mar. 25, 2013

(51) Int. Cl. G06Q 50/22; G06Q 10/10

(52) U.S. Cl. CPC G06Q 50/22; G06Q 10/1097
USPC 705/2

(57) ABSTRACT

A method and system for the electronic scheduling of events are disclosed. Schedulers log into an electronically networked scheduling system to electronically submit event requests. Requests include entry of patient data together with at least one of: procedure date, procedure place, procedure time, required equipment, requested medical personnel, as part of the first medical procedure request. Once request is accepted by the scheduling system, electronic notifications about the request are automatically sent over a data network to parties associated with the medical procedure. System enables rescheduling or resolution where scheduling conflicts, incorrect data, and unavailable equipment are indicated.

### CROSS REFERENCE TO RELATED APPLICATIONS

This patent application is a Continuation of U.S. Non-Provisional application Ser. No. 11/639,392, filed Dec. 13, 2006, entitled “Medical Case Scheduling, Logistics Management and Associated Data Management,” which claims the benefit under 35 U.S.C. §119(e) of U.S. Provisional Patent Application Serial. No. 60/750,148, filed on Dec. 13, 2005, entitled “Medical Case Scheduling, Logistics Management, and Associated Data Management.” The disclosures of the preceding applications are all incorporated herein by reference in their entirety.

### FIELD OF THE INVENTION

The present invention is related to automated data management solutions for use over data networks. More particular, the present invention is related to automated medical case scheduling, logistics management and associated data management. The systems described herein can be used by or on behalf of surgeons, medical facilities, and third party suppliers of services and equipment.

### BACKGROUND

Surgical case scheduling mishaps are commonplace in the medical field. Surgeons become increasingly frustrated with current processes to ensure proper logistics (e.g., instrumentation, facilities, and personnel) available for their surgeries. Those serving the medical profession are also frustrated with current processes. For example, medical equipment distributors can deliver everything necessary for a procedure to the hospital only to find out the case was cancelled or moved. Worse, a distributor may get called from the operating room by a surgeon wondering where the equipment is (e.g., why implants were not delivered or made sterile). Late delivered equipment may have to be sterilized in the autoclave, which is not the optimal way to sterilize implants.

Medical case scheduling and planning can result in error because so many people are involved in the process. Surgeons, medical assistants, hospital staff, medical distributors, and supporting specialists (e.g., anesthesiologists) must all be involved in the process prior to a scheduled operation. If one component in the process errs, the scheduled surgery may have to be cancelled, resulting with angry patients, surgeons, distributors, facilities, and support staff. It may be caused by a problem as simple as a medical assistant forgetting to call the medical distributor to place an order for necessary parts (e.g., artificial joints). Such errors cause medical professionals and distributors unnecessary stress and potential liability from disgruntled or harmed patients. Surgeons and their patients are put at risk because the patient may have to endure more OR time, be administered more anesthesia, and can suffer increased blood loss while the surgeon is waiting for equipment to arrive or other logistics to become available. Distributors may face the loss of business if a competitor must be called to provide an implant necessary to complete the scheduled case. Some loss of goodwill between the surgeon and losing distributor is inevitable no matter who was at fault.

Steps of medical scheduling and the distribution of medical devices currently occur as follows: the surgery scheduler verifies patient insurance coverage. If coverage is verified, typically 5 to 7 (or more) people will need to be notified of a scheduled case including: the hospital, support personnel, monitoring personnel, equipment vendors, and others, Scheduling is typically accomplished via telephone calls and faxes; although it can be appreciated that email communication can also be used. Unanswered phone calls or communications have to be returned by the scheduler.

Scheduling with so many parties involved is inefficient, inconsistent, and can lead to errors. Hospitals are prone to errors because so many facets of a case are handled at the operating facility. Hospital staff must schedule a time for the operation, which can include coordinating the schedule for necessary personnel (e.g., anesthesiologists). On the day of surgery, hospital staff must verify/secure equipment delivery, sterilize instruments and implants (if applicable), and notify the surgeon if equipment is not delivered or is late.

Medical device distributors are also prone to errors that may affect a scheduled case where the product is not shipped timely from the manufacturer, is mis-ordered, or the shipment is affected by resources outside of their control (e.g., transport carrier delays, bad weather). Inventory availability can affect shipment because product is shared within whole distributor systems (including several states) and inventory may be inadequate for coverage of the serviced market.

Much frustration and risk is experienced with faulty surgery scheduling. Many collateral issues also impact the scheduling process. For example, merging companies are creating confusion with the surgeons and hospitals. Distributors and Sales Reps are losing product lines as a result of company mergers, acquisitions, and sales. Manufacturers constantly change commission rate structures. Sales Reps territories keep getting cut. Scheduling conflicts are felt throughout the entire process.

Doctors face numerous challenges including: patient health risks, potential medical malpractice liability, frantic calls from the operating room staff prior to surgery because of a scheduling mishap, and a waste of time and energy on cases that are moved or cancelled without notification.

Healthcare providers also face their own share of challenges associated with or directly impacting scheduling such as: more services needed by patients, there are now more (and much older) patients to serve and liability for negligence caused by staff at the facility.

There is therefore a need for methods and/or systems that can prevent scheduling errors. There is also a need for systems and methods that enhance the overall scheduling process so that errors can be reduced or altogether avoided.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is an aspect of the disclosed embodiments to provide for improved automated data management solutions for use over data networks.

It is another aspect of the disclosed embodiments to provide for an improved automated event scheduling of an event.

It is a further aspect to provide for improved medical case scheduling, logistics management, and associated data management.

The above and other aspects can be achieved as is now described. A method and system for the electronic scheduling of events are disclosed. Schedulers log into an electronically networked scheduling system to electronically submit event requests. Requests include entry of patient data together with at least one of: procedure date, procedure place, procedure time, required equipment, requested medical personnel, as part of the first medical procedure request. Once a request is accepted by the scheduling system, electronic notifications about the request are automatically sent over a data network to parties associated with the medical procedure. System enables rescheduling or resolution where scheduling conflicts, incorrect data, and unavailable equipment are indicated.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates an exemplary operating platform for medical procedure scheduling, according to a preferred embodiment;

FIG. 2 illustrates an exemplary system architecture for implementing a medical case scheduling and associated data management system, according to an embodiment;

FIG. 3 illustrates an exemplary flow diagram of a method for scheduling a medical procedure, according to an embodiment;

FIG. 4 illustrates an exemplary flow diagram of steps recipients of electronic notification can carry out to reply to the system indicating a conflict with a proposed schedule, according to an embodiment;

FIG. 5 illustrates an exemplary flow diagram depicting optional actions that can be carried out by a consultant when used by a surgeon in a case, according to an embodiment;

FIG. 6 illustrates an exemplary flow diagram of how post surgery data can be handled, according to an embodiment;

FIGS. 7-12 illustrate exemplary electronic forms, which can also be represented as screen shots on a computer user interface utilized by the scheduler, in accordance with an exemplary medical case scheduling session by a scheduler, according to an embodiment; and

FIGS. 13-19 illustrate exemplary electronic notices that can be transmitted by the scheduling system for receipt by parties identified during the scheduling process as requiring notification, according to an embodiment.

### DETAILED DESCRIPTION

The particular values and configurations discussed in these non-limiting examples can be varied and are cited merely to illustrate at least one embodiment and are not intended to limit the scope thereof.

What is described herein are systems and methods that enable the scheduling and tracking of surgical cases over the internet using graphical user interfaces accessible to surgeons and logistics suppliers (both medical and support). The invention will also archive data in compliance with HIPAA requirements that will enable medical device manufacturing companies to learn information on surgical statistics, studies, and feedback on their products.

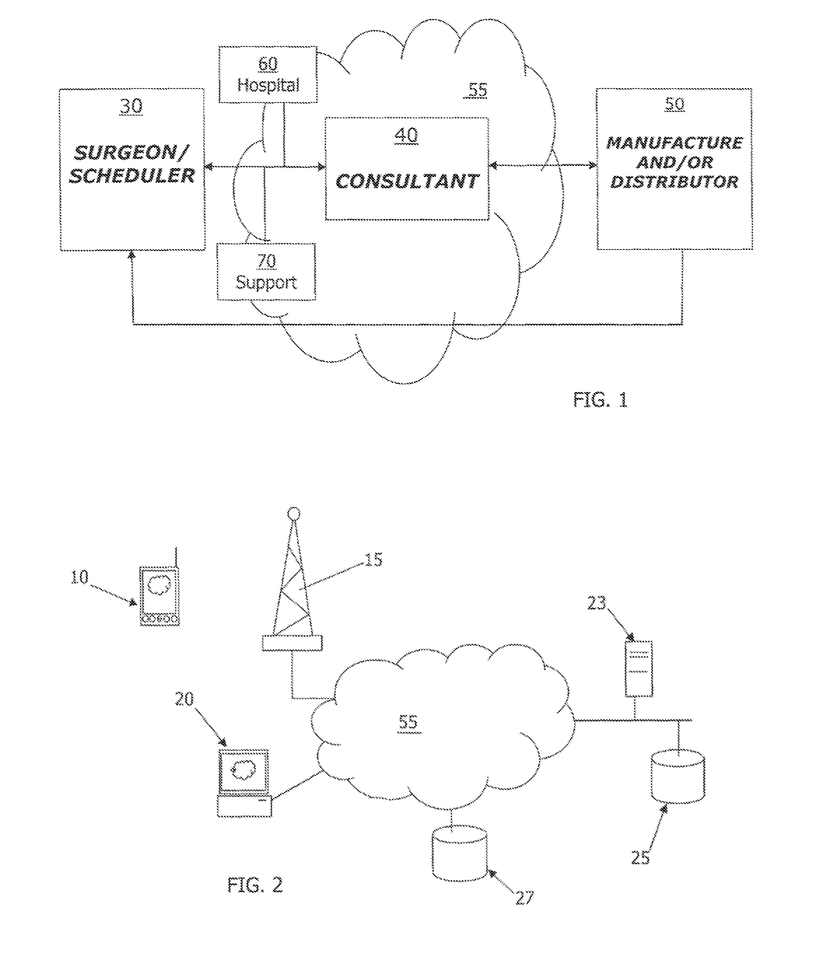

Referring to FIGS. 1 and 2, networked, interacting components of a medical case scheduling and associated data management system are illustrated. FIG. 1 represents an operating platform which will enable schedulers for medical providers (e.g., surgeons or schedulers operating on the surgeon's behalf) to successfully schedule medical procedures (e.g., surgeries), enable equipment distributors to accurately and timely provide the medical equipment (e.g., surgeons with implants that are needed for each surgical case), and medical facilities such as hospitals and necessary support personnel to be available and all be on the same page for a scheduled medical procedure. FIG. 2 illustrates a system architecture including hardware that can be used to successfully implement a medical case scheduling and associated data management system.

As shown in FIG. 1, planning and interaction can generally occur through a data network 55 between representatives of: a surgeon/scheduler 30, consultant 40, manufacturer/distributor 50, hospital staff 60, and support personnel 70. These parties are typically responsible for ensuring that a medical procedure such as a surgical case is ready to go within a medical facility, such as hospital operating room facilities, and will include the proper medical support personnel and equipment distributors. Hospital facilities 60 and support personnel 70 are important, traditional aspects of the scheduling process, but have not been automated as described herein. Consultants 40 and/or distributors 50 can be included as an important component of the automated scheduling process to ensure complete, accurate medical case scheduling is accomplished by all relevant entities.

Referring to FIG. 2, system architecture is illustrated of hardware that can be used to successfully implement a medical case scheduling and associated data management system. A surgeon, scheduler, consultant, distributor, hospital, and medical support personnel can communicate with the medical case scheduling and associated data management system using office computers 20 and/or wireless communication devices 10 and associated communications hardware 15 over an electronic data network 55. The data network 55 facilitates the transfer of scheduling and management processes between users. A combination of servers 23 and databases 25 and 27 can be used in the system to maintain records and facilitate the scheduling and data management processes. The scheduling system can be carried out with a computer having online access to a remote scheduling server including scheduling software, or can include the use of a local computer having network access to a remote scheduling server but having the scheduling software, including modules loaded onto the local computer for enabling a scheduler to log into the scheduling system, enter scheduling data into the scheduling system, and connect with parties to provide data to parties through the system including sending/receiving notifications to/from the system.

Medical cases all begin with a surgeon-patient examination. A surgeon/scheduler then books a surgical case for the patient. In most offices, the surgeon typically fills out a scheduling form (e.g., data sheet) while the patient is present. The surgeon might then give this data sheet to his scheduler and the scheduler does the scheduling by notifying all parties required for a case. Notification typically occurs telephonically or via email. What occurs following the physical collection of data by the surgeon and/or the creation of the sheet can be automated in accordance with features of the present invention.

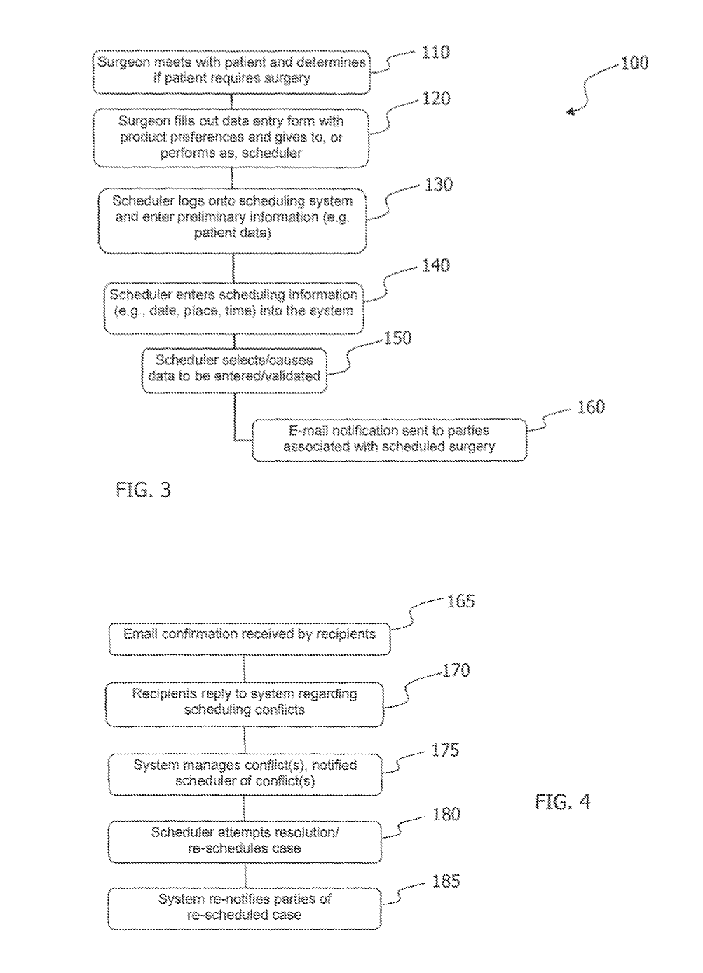

Referring to flow diagram 100 illustrated in FIG. 3, certain steps can be carried out to schedule a medical procedures (e.g., surgical case). This example is for a surgery, although other medical procedures can be assumed as well. As shown in Step 110, the surgeon first consults with a patient and determines whether surgery is necessary. As shown in Step 120, the surgeon fills out a scheduling form (typically paper-based) and gives the filled out form to a staff person who will perform as a scheduler. It should be appreciated that the surgeon can also be the scheduler and perform scheduling tasks as indicated in Step 120. It should also be appreciated that data can be entered into a system directly, using user interfaces that are typically associated with networked computers, without the need to fill out a form.

As shown in Step 130, the scheduler/surgeon logs onto a scheduling system and enters information necessary to successfully schedule the case. It is important that the scheduler enters all pertinent information regarding the surgical case and that is minimally necessary to accomplish scheduling of a case. For example, the scheduler can enter the patient information, insurance info, ICD-9 codes, CPT-4 codes, and identify all the equipment needed for the case. Needed equipment can include, for example, implants, a particular OR table/room, and a C-arm if needed. The scheduler can also enter other data into the system such as requests for a particular consultant, monitoring or Durable Medical Equipment (DME).

Information entered by the scheduler can be broken into two categories: preliminary information and scheduling information. Preliminary information (or “Patient data”) provided by the scheduler can include patient identifying data insurance data, CPT-4, and ICD-9 codes, etc. As shown in Step 140, the scheduler can use the system to select surgical event information including a surgery date, hospital, equipment (e.g., medical prosthetics), and support personnel. As shown is Step 150, the scheduler can cause the entered data to be validated by the scheduling system. Validation can simply include automatic confirmation by the system that all required data has been entered. If the data is acceptable, the system will send out electronic confirmations as shown in Step 160. For example, emails can be sent to: surgeon, hospital, anesthesia, cell saver, bracing, spinal cord monitoring, and anyone pertinent to the surgical case. If the data is not acceptable (i.e., due to inaccurate data entry, scheduling conflicts, and/or equipment shortage), the scheduler will be required to repeat step 140.

It should be appreciated that the system can accept the data entered in Step 140 following user action at Step 150 without validation as shown in Step 160. In such a case, electronic notifications (e.g., email) would be sent out to the parties confirming the scheduled case immediately following step 150. As shown in FIG. 4, after confirmation is received by recipients as shown in Step 165, the recipient parties of email notification can reply to the system indicating a conflict with the schedule as shown in Step 170. As shown in Step 175, the system can manage notification of the scheduling conflict for all parties. If a conflict is determined to exist by the system, the system can notify the scheduler who can then resolve the conflict by attempting to reschedule the case as shown in Step 180. Once rescheduled, the system will re-notify all parties of the rescheduled case via email as shown in Step 185. It should be appreciated that notification of a rescheduled case may only include a change in at least one of the parameters necessary to fulfill a case (i.e., a change of at least one of: surgery time and date, hospital, support staff, equipment, etc.).

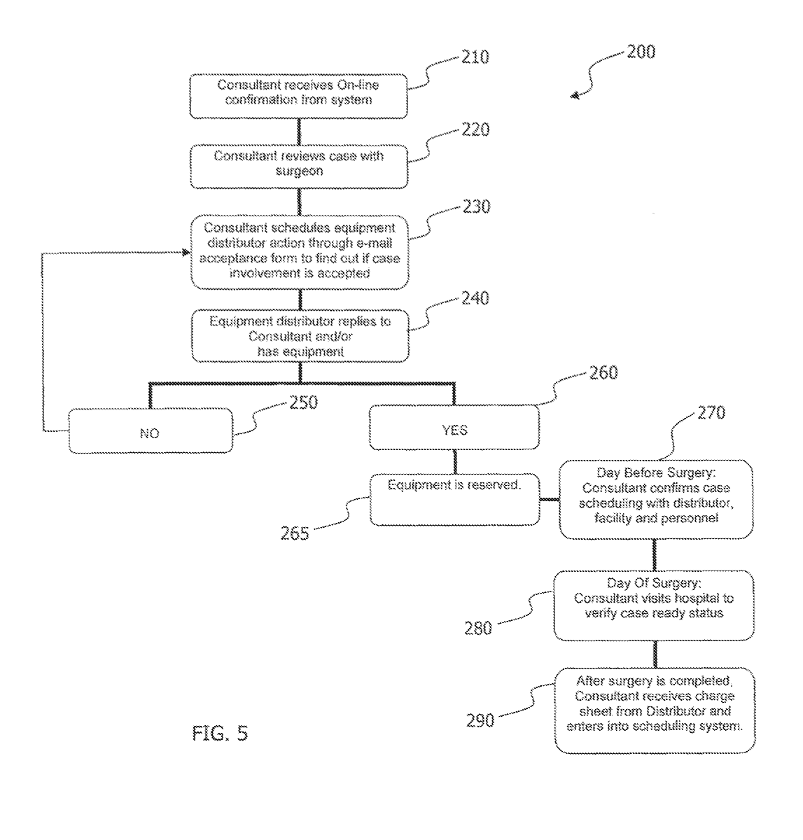

Referring to FIG. 5, a flow diagram 200 depicting optional actions that can be carried out by a consultant when used by a surgeon in a case is illustrated. As shown in Step 210, a consultant receives an on-line confirmation from the system (scheduler). As shown in Step 220, the consultant can review the scheduled case with the surgeon (or the surgeon's staff). As shown in Step 230, the consultant can schedule equipment with the vendor of choice of the surgeon. The distributor is notified (e.g., orders) through an e-mail acceptance form to find out if the distributor accepts involvement in the case. As shown in Step 240, the equipment distributor replies to the consultant and can confirm equipment availability. If equipment is not available from the distributor as shown in block 250, the consultant can find another distributor or equipment source as shown by the flow diagram's return to step 230. If the equipment is available as show in Step 260, equipment is reserved as shown in Step 265.

As shown in Step 270, the consultant can be used to confirm scheduling with the equipment distributor, hospital, and support personnel one day before the surgery is scheduled. On the day of surgery, the consultant can visit the hospital and make sure that the case is ready as shown in Step 280. After a surgery is completed, the consultant can receive a charge sheet from the distributor and enters it into the scheduling system for billing, as shown in Step 290.

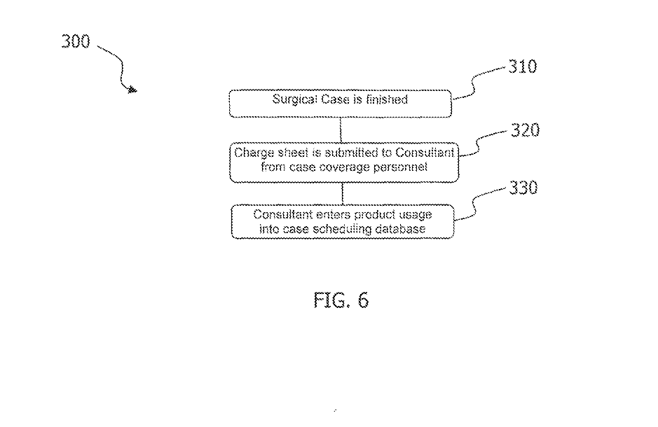

Referring to FIG. 6, a flow diagram 300 illustrating post surgery data handling is shown. As shown in Step 310, a surgical case comes to completion. In Step 320, a charge sheet can be submitted to the hospital and consultant from case coverage personnel. The consultant enters the product usage information into the case scheduling database as shown in Step 330, wherein the data can be kept for future retrieval and used by the surgeon and interested third parties.

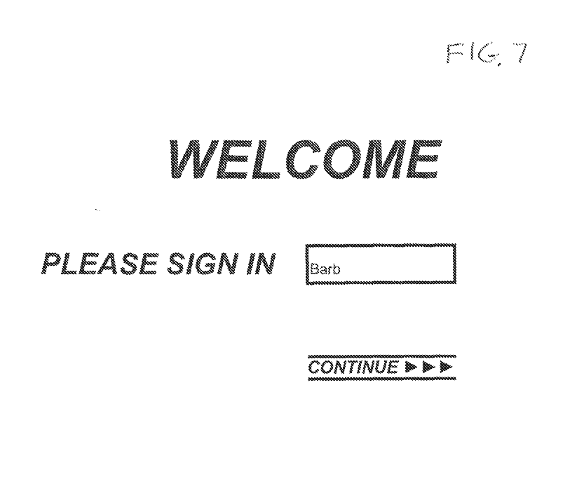

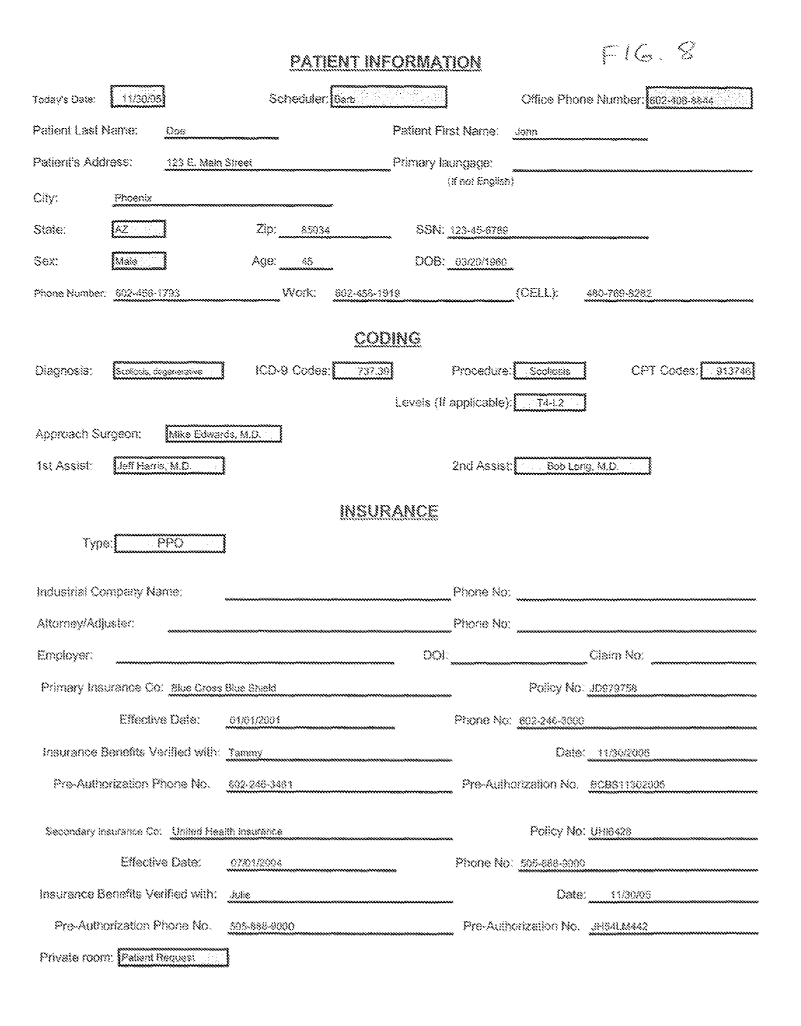

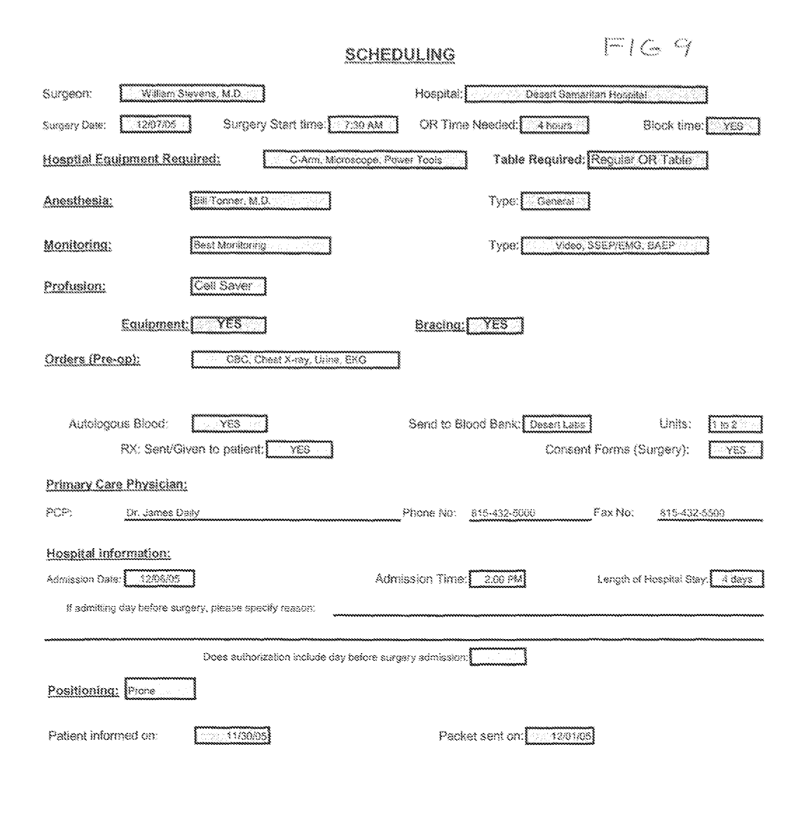

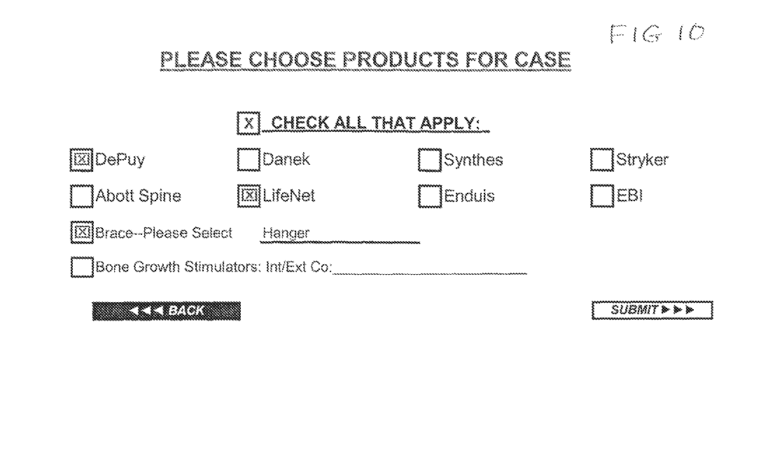

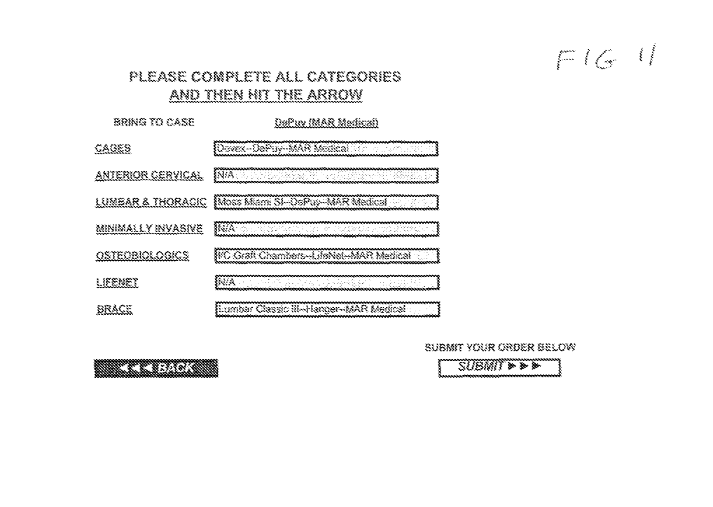

FIGS. 7-12 illustrate electronic forms, which can also be represented as screen shots on a computer utilized by the scheduler, in accordance with an exemplary medical case scheduling session by “Barb” the scheduler. Referring to FIG. 7, the scheduler enters the scheduling system and is greeted on the graphical user interface by a “Welcome” page whereon the scheduler is asked to sign in. Surgeons will have a way to control access to their accounts. If scheduler terminates employment with a surgeon, a surgeon will be able to prevent access to the scheduling system by the terminated employee so that patient data is protected. Once the scheduler is signed in and authenticated, the scheduler can begin entering patient information into the system, as shown in FIG. 8. The patient information can be what was referred to above as “preliminary information”. After the patient information is entered, the scheduler can enter “scheduling” data into the system, as shown in FIG. 9.

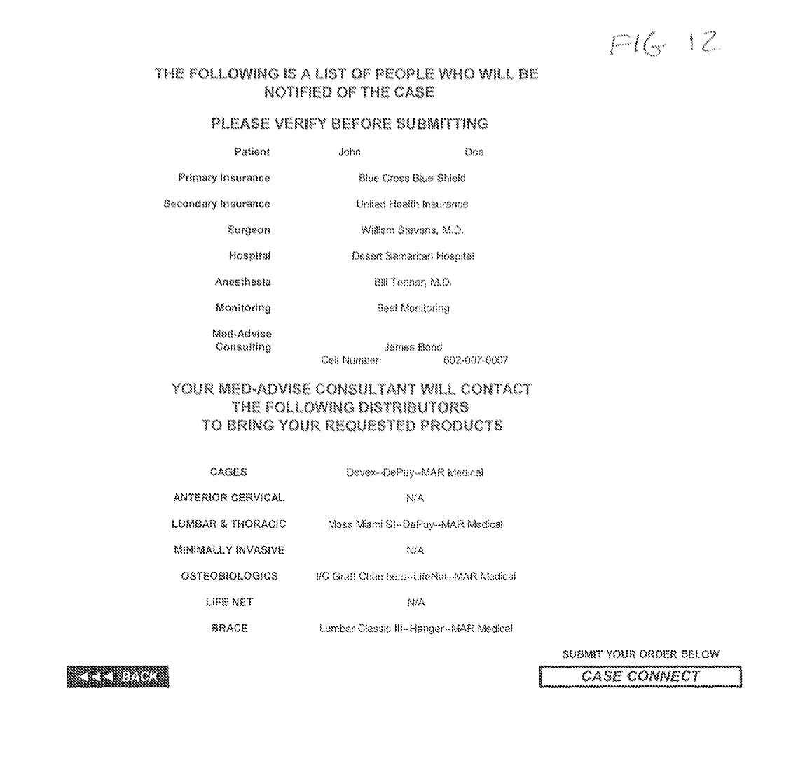

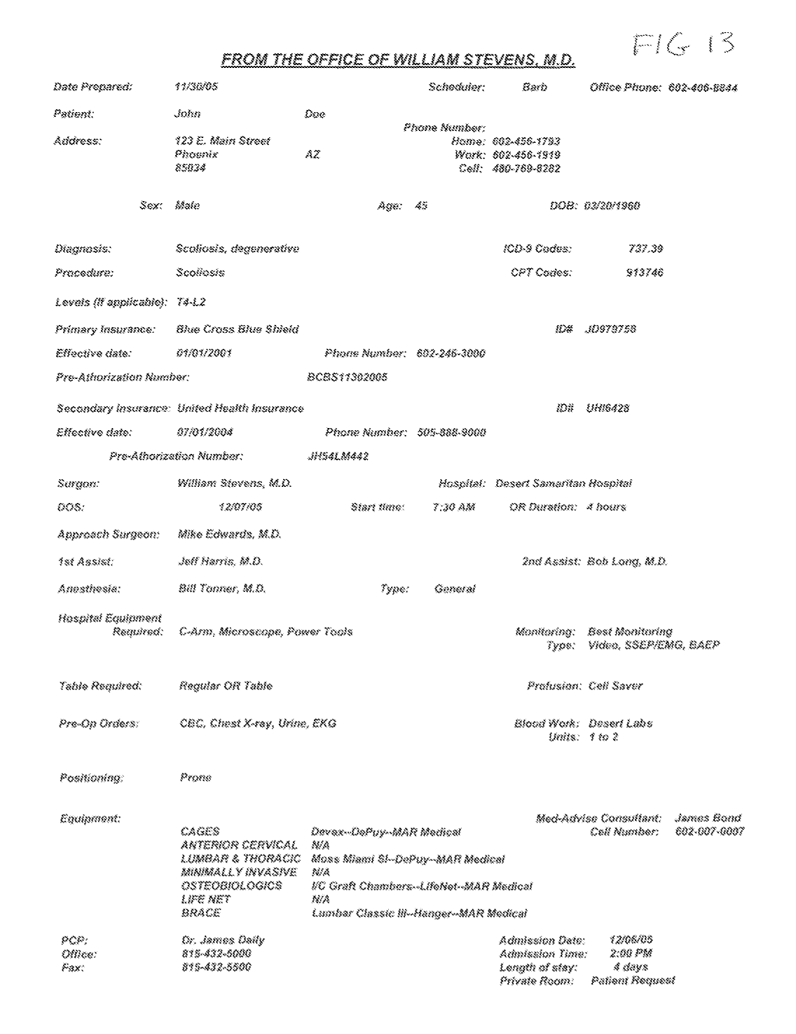

Enough information to schedule a surgical case has been entered in FIG. 9; however, it can be appreciated that additional information related to equipment, such as prosthetics, can be a useful component of scheduling a surgery. As shown in FIG. 10, the scheduler can also optionally choose equipment needed for the type of surgery identified in FIG. 9. The “Back” button in FIG. 10 enables the scheduler to return to the previous scheduling page to make corrections (e.g., in case equipment options are incorrect based on the type of surgery entered), Once the equipment is chosen, it can be submitted to the system using the “Submit” button on the form represented by FIG. 10. The scheduler can be directed to another equipment-related page, as shown in FIG. 11, wherein additional categories or information related to the equipment chosen on Page 10 can be entered. Again, the “Back” and “Submit” buttons can be selected by the scheduler following data entry. FIG. 12 illustrates the last page that the scheduler will encounter during the scheduling of a surgical case. In FIG. 12, the scheduler will identify the parties that should be electronically notified of the scheduled case. Where a consultant is used, the scheduler can also identify parties that the consultant can contact on the schedulers behalf (typically manufacturers or distributors of equipment). Once all the parties requiring notification have been identified by the scheduler, the scheduler can complete the process of scheduling the case by selecting the “Case Connect” button on the graphical user interface. Once the data is submitted to the scheduling system, the parties will be notified. Notification can occur after the system has validated the data as discussed above with respect to FIG. 3, or immediately after entry the by scheduler as discussed with respect to FIG. 4.

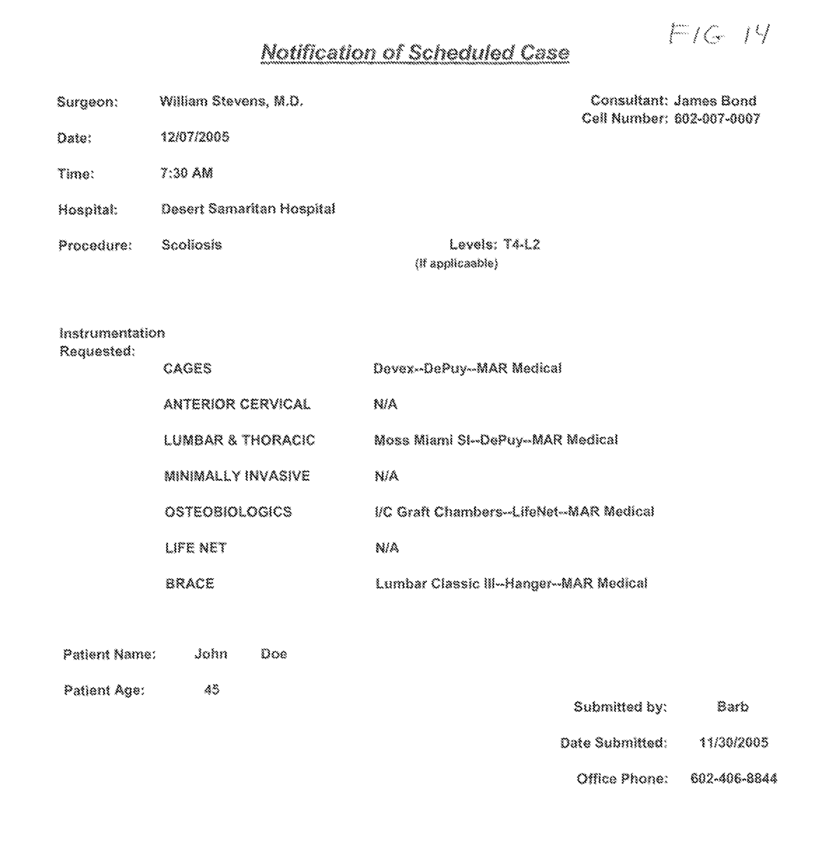

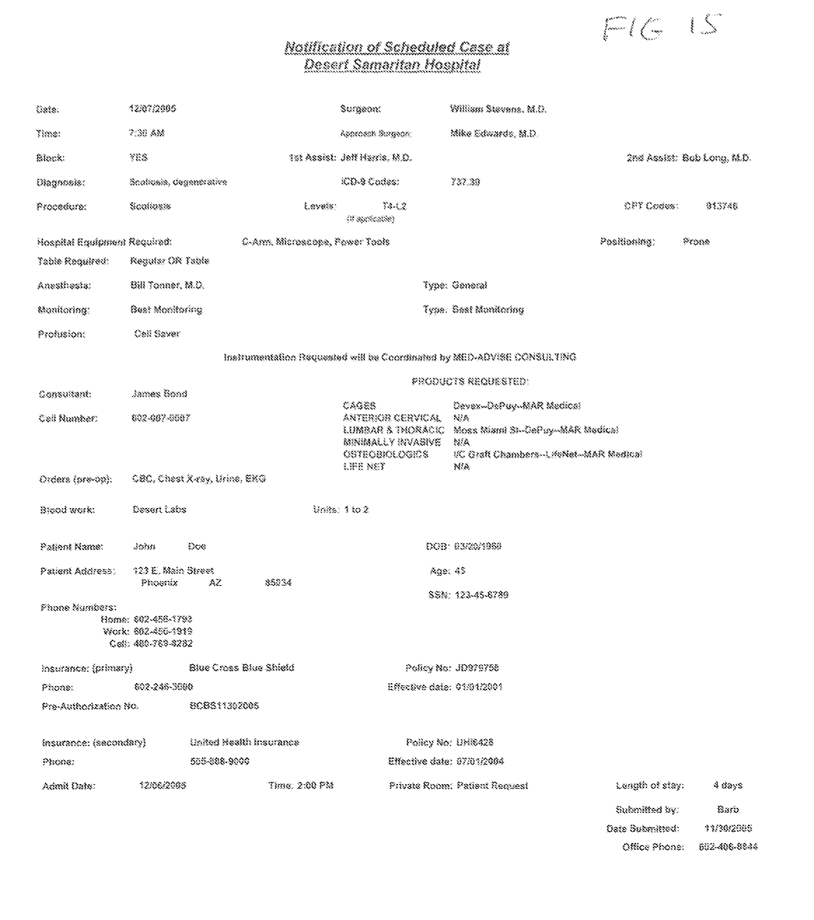

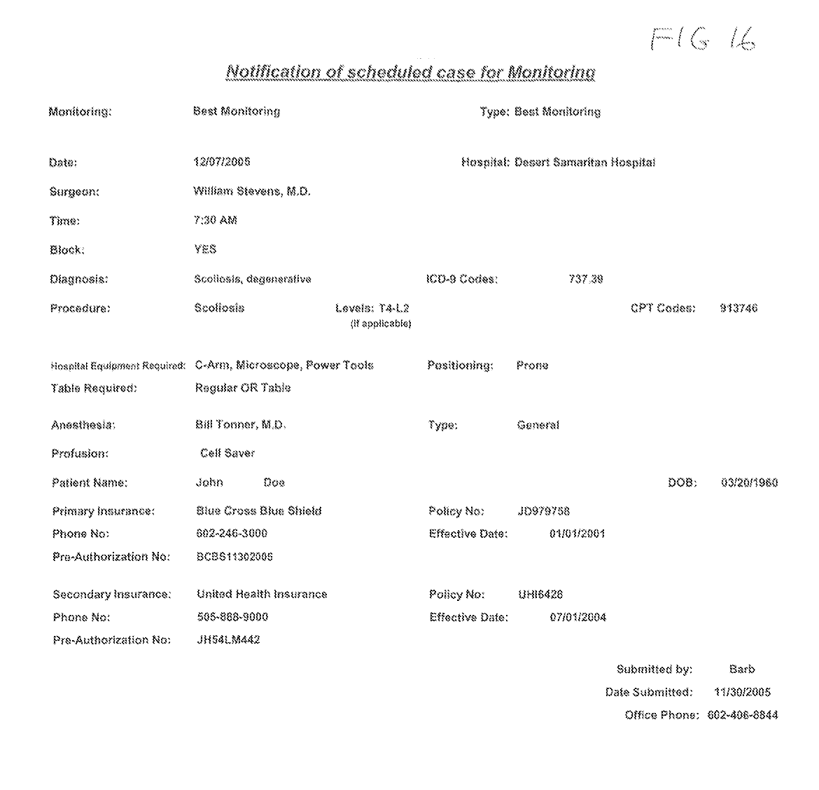

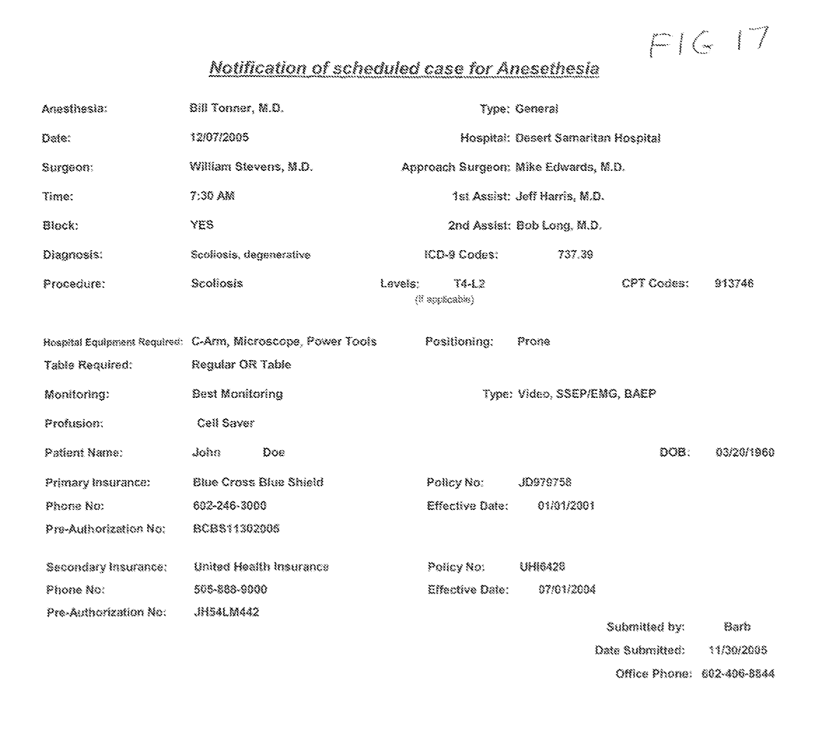

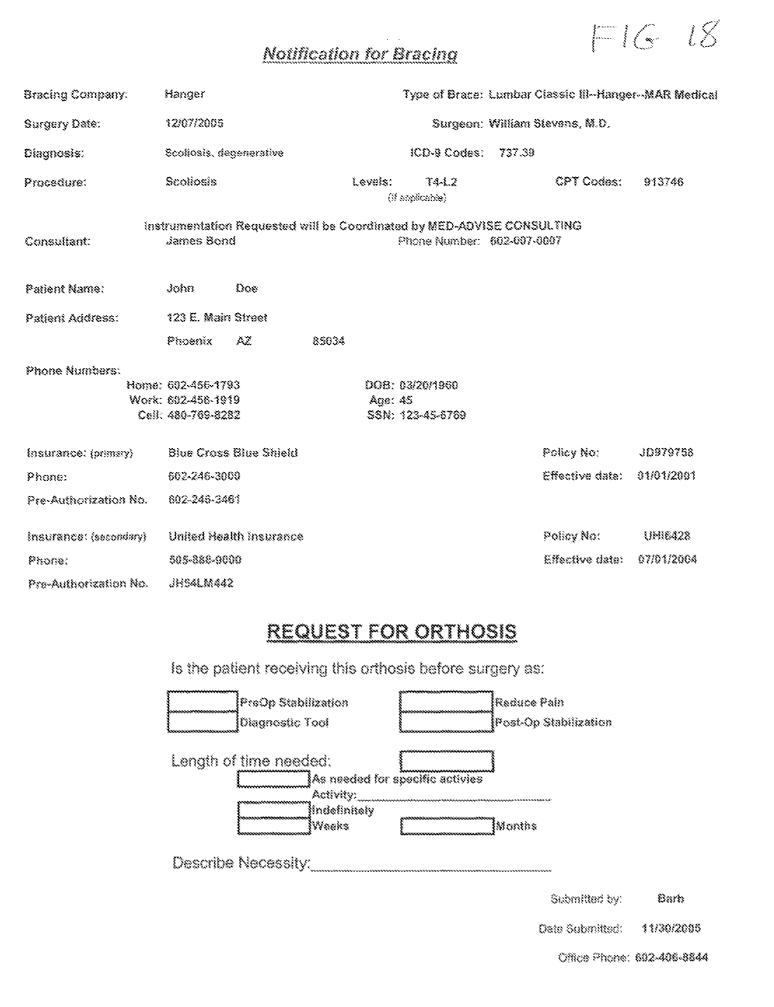

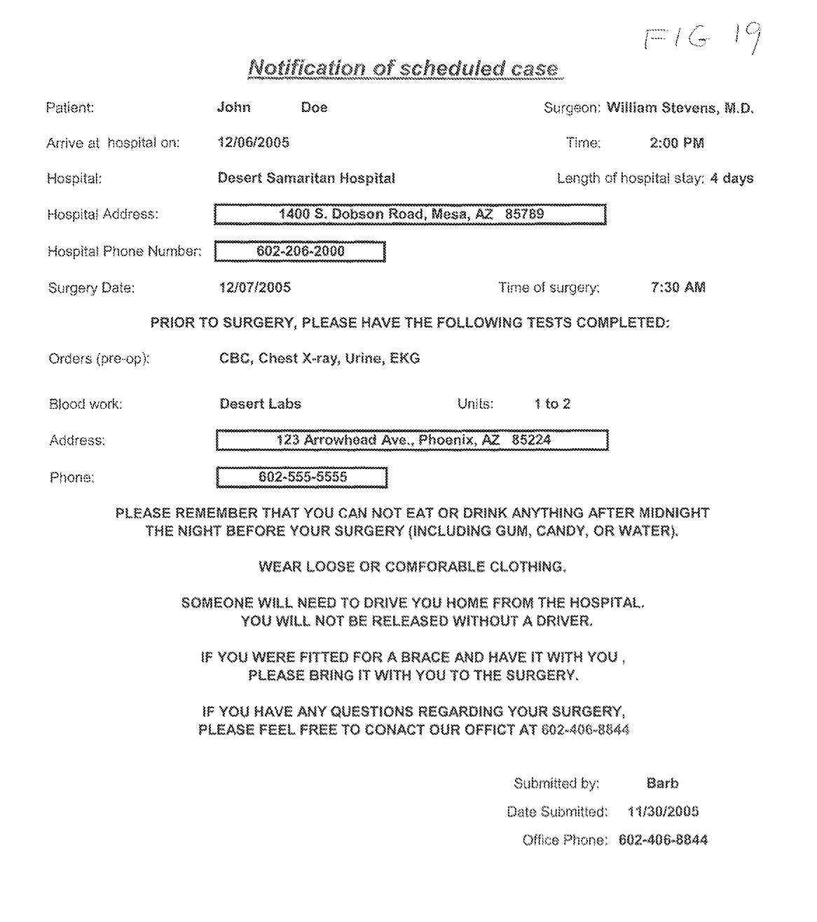

FIGS. 13-19 illustrate electronic notices that can be transmitted by the system for receipt by parties identified during the scheduling process as requiring notification. Once official entry of the data is selected, all the information is routed to the appropriate entities (e.g., hospital, doctor, profusion, SSEP monitoring, and anyone else that needs the information). Scheduling information can be received via e-mail. FIGS. 13-18 illustrate examples of letters that would go to surgeons, hospitals, support personnel, and equipment providers. FIG. 19 illustrates an example of a letter that can be sent or electronically transmitted to the patient and provides the patient with, inter alia, scheduled case information, pre-operative requirements (e.g., “do not eat after midnight . . . ”), and point of contact information.

Optionally, a consultant (and as discussed above) responsible for supplying equipment can also be emailed. Following notification, the consultant can work on ensuring that all necessary equipment is made available for the scheduled case. The consultant can be designated as the agent of record for the surgeon's scheduled surgical cases. The consultant can call or email the equipment vendors that have been requested by the surgeon. The case can be available online with limited information for the manufacture and they will need to decide if they want the case. Because the consultant can be designated as the agent of record with the surgeon, the equipment vendors can be required to accept an online agreement of terms and conditions including an agreement to pay the consultant a case referral fee. Once the equipment vendor dicks to accept the terms and conditions of the case, specific case information can be revealed. If the equipment vendor has what the surgeon needs, it can be ordered by the consultant. If the equipment vendor does not have the equipment (e.g., a set or enough implants) to accomplish the surgery, the consultant can call another equipment vendor as a back up. It can be left up to the consultant working on behalf of the surgeon to be sure everything is ready for each case.

Equipment vendors generally deliver the implants to the hospital. On the day of surgery, the equipment vendor can appoint a case coverage representative to cover and break down the equipment after the case. Consultants, when used, generally should not and probably will not deliver equipment, or cover the case and break down the case. It is typically, and can be made, the sole responsibility of the equipment vendors to provide these services.

As can be appreciated from the methods steps outlined above, the scheduling system can be a tremendous asset to surgeons. In accordance with a method of doing business, a scheduling system vendor can license surgeons to use the system for no charge in exchange for the surgeons' use of the system and vendor consulting services. The consultant can train the office staff and the surgeon on how to enter the cases into the system and can consult with third party vendors that need to be kept abreast of the case for supply purposes.

In addition, the consultant can offer the surgeon various opportunities to become involved with companies that are looking to conduct research thru pre and post marketing studies. Consultants can also facilitate any 510K or possible IDE studies that companies are generally interested in.

The scheduling system and methods described herein can enable surgeons to run a much better operation and they will have the ability to get real-time information regarding their schedules and surgical cases. The system can enable surgeons to use the scheduling system to search for past surgeries or implants used by searching the date, hospital, patient name or the ICD-9 codes. This can allow a surgeon to respond better to patients that may need revision surgery. The surgeons and their schedulers can log onto the scheduling system anywhere there is an internet connection.

Surgeons will own their patient data and vendors might be able to own the demographic data. Surgeons should be able to take their information with them if they changed practices or employment. It is important that data goes with the surgeon that conducted the surgery. Patient data that is entered into the system should generally belong to the surgeon and if the surgeon were to leave their practice, the data can easily follow the surgeon given the architecture of the present system. The demographic data that is collected, however, can remain the property of the scheduling system vendor and can be compiled in a searchable database for statistical and other future uses that do not violate privacy laws, or HIPAA.

Data maintained by surgeons in a database can be searchable. A surgeon can find information about a patient or surgeries conducted in the past by looking up that patient's name or the surgery type. Other information can be researched as well in a searchable database. Such information can be helpful to medical practice. Surgeons often store paper files yet do not have easy access to them. Surgeon reports for different types of surgery (like how many anterior cervical cases has the surgeon done in the past 6 months or at a particular hospital) can be very valuable information to the surgeon. This type of information can also be valuable to equipment suppliers, service providers, insurance companies, etc. The system can store information by demographic group (e.g., city, state, sex, age group . . . ) without breaching privacy.

Based on the foregoing, it can be appreciated that a number of different embodiments, preferred and alternative, are disclosed herein. For example, in one embodiment, a scheduling method is disclosed. The method can comprise the steps of: accessing an electronically networked scheduling system; entering scheduling request data together with at least one of: preliminary information, identification data, scheduling information, event date, event place, event time, required equipment, requested personnel, into the electronically networked scheduling system as part of a first request; and accepting the first request into the electronically networked scheduling system.

In other embodiments, the method further comprises automatically sending an electronic notification of the first request via the electronically networked scheduling system to an information recipient, wherein the information recipient comprises at least one entity. In another embodiments, the at least one entity comprises a hospital, medical support personnel, medical personnel, an equipment distributor, a consultant, a scheduler, a physician, a surgeon, a nurse, an insurance company, an equipment manufacturer, and a patient.

In an embodiment, the method further comprises indicating a conflict, inaccurate data entry, or an equipment shortage in the first request from at least one entity, wherein scheduling request data is entered into the electronically networked scheduling system the second request including the identification data and changes to at least one of: the case date, the case place, the case time, the required equipment, the requested personnel, and accepting the second request into the electronically networked scheduling system. In another embodiment, the method further comprises automatically sending an electronic re-notification of the second request via the electronically networked scheduling system to an information recipient, wherein the information recipient comprises at least one entity, wherein the at least one entity comprises a hospital, medical support personnel, medical personnel, an equipment distributor, a consultant, a scheduler, a physician, a surgeon, a nurse, an insurance company, an equipment manufacturer, and a patient.

It yet another embodiment, the method further comprises: scheduling necessary equipment for the first request via the electronically networked scheduling system; confirming necessary equipment availability for the first request via the electronically networked scheduling system; and reserving necessary equipment for the first request via the electronically networked scheduling system. In other embodiments, the method comprises receiving payment request information associated with the first request into the electronically networked scheduling system and submitting payment request information from the electronically networked scheduling system to hospital personnel, an insurance company, or a patient for payment associated with the first request.

Another embodiment discloses a scheduling system comprising a processor; a data bus coupled to the processor: and a computer-usable non-transitory storage medium embodying computer code, the computer-usable non-transitory storage medium being coupled to the data bus, the computer program code comprising program instructions executable by the processor, the program instructions comprising instructions to: access an electronically networked scheduling system; enter scheduling request data together with at least one of: preliminary information, identification data, scheduling information, event date, event place, event time, required equipment, requested personnel into the electronically networked scheduling system as part of a first request; and program accept the first request into the electronically networked scheduling system. Embodiments of the system include program instructions of the method.

In yet another embodiment, a computer-usable non-transitory storage device storing computer program code for scheduling is disclosed. The computer program code comprises program instructions executable by a processor. The program instructions comprises instructions to: access an electronically networked scheduling system; enter scheduling request data together with at least one of: preliminary information, identification data, scheduling information, event date, event place, event time, required equipment, requested personnel into the electronically networked scheduling system as part of a first request; and accept the first request into the electronically networked scheduling system. Embodiments of the computer-usable non-transitory storage device storing computer program code include program instructions of the method.

It will be appreciated that variations of the above-disclosed and other features and functions, or alternatives thereof, may be desirably combined into many other different systems or applications. Furthermore, various presently unforeseen or unanticipated alternatives, modifications, variations or improvements therein may be subsequently made by those skilled in the art which are also intended to be encompassed by the following claims.

What is claimed is:

1. A scheduling method, comprising:
accessing an electronically networked scheduling system:
entering scheduling request data together with at least one of: preliminary information, identification data, scheduling information, event date, event place, event time, required equipment, requested personnel into the electronically networked scheduling system as part of a first request; and
accepting the first request into the electronically networked scheduling system.

2. The method of claim 1 further comprising automatically sending an electronic notification of the first request via the electronically networked scheduling system to an information recipient, wherein the information recipient comprises at least one entity.

3. The method of claim 2 wherein the at least one entity comprises a hospital, medical support personnel, medical personnel, an equipment distributor, a consultant, a scheduler, a physician, a surgeon, a nurse, an insurance company, an equipment manufacturer, and a patient.

4. The method of claim 1 further comprising indicating a conflict, inaccurate data entry, or an equipment shortage in the first request from at least one entity, wherein scheduling request data is entered into the electronically networked scheduling system the second request including the identification data and changes to at least one of: the case date, the case place, the case time, the required equipment, the requested personnel, and accepting the second request into the electronically networked scheduling system.

5. The method of claim 1 further comprising automatically sending an electronic re-notification of the second request via the electronically networked scheduling system to an information recipient, wherein the information recipient comprises at least one entity, wherein the at least one entity comprises a hospital, medical support personnel, medical personnel, an equipment distributor, a consultant, a scheduler, a physician, a surgeon, a nurse, an insurance company, an equipment manufacturer, and a patient.

6. The method of claim 1 further comprising:
scheduling necessary equipment for the first request via the electronically networked scheduling system;
confirming necessary equipment availability for the first request via the electronically networked scheduling system; and
reserving necessary equipment for the first request via the electronically networked scheduling system.

7. The method of claim 1 further comprising receiving payment request information associated with the first request into the electronically networked scheduling system and submitting payment request information from the electronically networked scheduling system to hospital personnel, an insurance company, or a patient for payment associated with the first request.

8. A scheduling system, comprising:
a processor;
a data bus coupled to said processor; and
a computer-usable non-transitory storage medium embodying computer code, said computer-usable non-transitory storage medium being coupled to said data bus, said computer program code comprising program instructions executable by said processor, said program instructions comprising instructions to:
access an electronically networked scheduling system;
enter scheduling request data together with at least one of: preliminary information, identification data, scheduling information, event date, event place, event time, required equipment, requested personnel into the electronically networked scheduling system as part of a first request; and
accept the first request into the electronically networked scheduling system.

9. The system of claim 8 further comprising program instructions to automatically send an electronic notification of the first request via the electronically networked scheduling system to an information recipient, wherein the information recipient comprises at least one entity.

10. The system of claim 9 wherein the at least one entity comprises a hospital, medical support personnel, medical personnel, an equipment distributor, a consultant, a scheduler, a physician, a surgeon, a nurse, an insurance company, an equipment manufacturer, and a patient.

11. The system of claim 8 further comprising program instructions to indicate a conflict, inaccurate data entry, or an equipment shortage in the first request from at least one entity, wherein scheduling request data is entered into the electronically networked scheduling system the second request including the identification data and changes to at least one of: the case date, the case place, the case time, the required equipment, the requested personnel, and accepting the second request into the electronically networked scheduling system.

12. The system of claim 8 further comprising program instructions to automatically send an electronic re-notification of the second request via the electronically networked scheduling system to an information recipient, wherein the information recipient comprises at least one entity, wherein the at least one entity comprises a hospital, medical support personnel, medical personnel, an equipment distributor, a consultant, a scheduler, a physician, a surgeon, a nurse, an insurance company, an equipment manufacturer, and a patient.

13. The system of claim 8 further comprising program instructions to:
schedule necessary equipment for the first request via the electronically networked scheduling system;
confirm necessary equipment availability for the first request via the electronically networked scheduling system; and
reserve necessary equipment for the first request via the electronically networked scheduling system.

14. The system of claim 8 further comprising program instructions to receive payment request information associated with the first request into the electronically networked scheduling system and program instructions to submit payment request information from the electronically networked scheduling system to hospital personnel, an insurance company, or a patient for payment associated with the first request.

15. A computer-usable non-transitory storage device storing computer program code for scheduling, said computer program code comprising program instructions executable by a processor, said program instructions comprising instructions to;
access an electronically networked scheduling system;
enter scheduling request data together with at least one of: preliminary information, identification data, scheduling information, event date, event place, event time, required equipment, requested personnel, into the electronically networked scheduling system as part of a first request; and
accept the first request into the electronically networked scheduling system.

16. The computer-usable non-transitory storage device of claim 15 further comprising program instructions to automatically send an electronic notification of the first request via the electronically networked scheduling system to an information recipient, wherein the information recipient comprises at least one entity.

17. The computer-usable non-transitory storage device of claim 16 wherein the at least one entity comprises a hospital, medical support personnel, medical personnel, an equipment distributor, a consultant, a scheduler, a physician, a surgeon, a nurse, an insurance company, an equipment manufacturer, and a patient.

18. The computer-usable non-transitory storage device of claim 15 further comprising program instructions to indicate a conflict, inaccurate data entry, or an equipment shortage in the first request from at least one entity, wherein scheduling request data is entered into the electronically networked scheduling system the second request including the identification data and changes to at least one of: the case date, the case place, the case time, the required equipment, the requested personnel, and accepting the second request into the electronically networked scheduling system.

19. The computer-usable non-transitory storage device of claim 15 further comprising program instructions to automatically send an electronic re-notification of the second request via the electronically networked scheduling system to an information recipient, wherein the information recipient comprises at least one entity, wherein the at least one entity comprises a hospital, medical support personnel, medical personnel, an equipment distributor, a consultant, a scheduler, a physician, a surgeon, a nurse, an insurance company, an equipment manufacturer, and a patient.

20. The computer-usable non-transitory storage device of claim 15 further comprising instructions to:
schedule necessary equipment for the first request via the electronically networked scheduling system;
confirm necessary equipment availability for the first request via the electronically networked scheduling system:
reserve necessary equipment for the first request via the electronically networked scheduling system; and
receive payment request information associated with the first request into the electronically networked scheduling system and program instructions to submit payment request information from the electronically networked scheduling system to hospital personnel, an insurance company, or a patient for payment associated with the first request.
